(19) United States
(12) Patent Application Publication
(10) Pub. No.: US 2025/0088784 A1
(43) Pub. Date: Mar. 13, 2025

(54) KNOB STRUCTURE FOR ADJUSTING SOUND PARAMETER AND HEADPHONE INCLUDING KNOB STRUCTURE

(71) Applicant: PRIMAX ELECTRONICS LTD., Taipei City (TW)

(72) Inventors: CHUN-NAN SU, Taipei City (TW); Chun-Che Wu, Taipei City (TW); Yao-Chung Hsieh, Taipei City (TW); Jyun-Ci Chen, Taipei City (TW)

(21) Appl. No.: 18/487,491

(22) Filed: Oct. 16, 2023

(30) Foreign Application Priority Data
Sep. 8, 2023 (TW) 112134320

(51) Int. Cl. H04R 1/10

(52) U.S. Cl. CPC H04R 1/1041

(57) ABSTRACT

A knob structure for adjusting a sound parameter is provided, which includes a knob, an encoder, an interference component and a switching module. The knob has a shaft portion and an internal teeth portion. The encoder is connected to the shaft portion of the knob, in which the encoder includes a turntable and a bottom plate. The turntable has one or more protrusions in contact with the bottom plate. When the knob is rotated to rotate the turntable of the encoder, the one or more protrusions rub against the bottom plate. The interference component has a first end adjacent to the internal teeth portion of the knob. The switching module is configured to make the first end of the interference component be in contact with or moved away from the internal teeth portion of the knob. A headphone including the knob structure is also provided.

### FIELD OF THE INVENTION

The present disclosure relates to a knob structure for adjusting a sound parameter and a headphone including the knob structure. In particular, the present invention relates to a knob structure for adjusting a sound parameter that can provide two operating feels and a headphone including the knob structure.

### BACKGROUND OF THE INVENTION

Volume of an existing sound source input device is adjusted through a scroll wheel with a single step-feel design or a stepless-feel design. However, the user sometimes needs to adjust the volume greatly and sometimes needs to adjust the volume finely. Therefore, the scroll wheel of the sound source input device is inconvenient for the user. In addition, an operating feel of the scroll wheel with the stepless-feel design is unclear.

### SUMMARY OF THE INVENTION

The present disclosure provides a knob structure for adjusting a sound parameter, which includes a knob, an encoder, an interference component and a switching module. The knob has a shaft portion and an internal teeth portion. The encoder is connected to the shaft portion of the knob, in which the encoder includes a turntable and a bottom plate. The turntable has one or more protrusions in contact with the bottom plate. When the knob is rotated to rotate the turntable of the encoder, the one or more protrusions rub against the bottom plate. The interference component has a first end adjacent to the internal teeth portion of the knob. The switching module is configured to make the first end of the interference component be in contact with or moved away from the internal teeth portion of the knob.

In some embodiments of the present disclosure, the encoder has an opening that accommodates a portion of the shaft portion of the knob.

In some embodiments of the present disclosure, the switching module includes: a side cover, in which the knob further has an outer diameter portion, and the side cover is adjacent to a portion of the outer diameter portion and has a pressing portion facing away from the knob; a switch, abutting against the pressing portion; a connecting member, in which the interference component further has a second end opposite to the first end, and the connecting member is connected to the second end of the interference component; and a driving member, configured to move the connecting member, in which when the knob is pressed, the portion of the outer diameter portion of the knob is pushed against the side cover, causing the pressing portion of the side cover to press the switch to drive the driving member, so that the connecting member and the second end of the interference component are moved, so that the first end of the interference component is in contact with or moved away from the internal tooth portion.

In some embodiments of the present disclosure, the connecting member has a first opening that accommodates the second end of the interference component.

In some embodiments of the present disclosure, the knob structure further includes: an outer casing, having an opening region exposing another portion of the outer diameter portion of the knob.

In some embodiments of the present disclosure, the knob structure further includes: a first torsion spring, connected between the side cover and the outer casing.

In some embodiments of the present disclosure, the switching module further includes: a permanent magnet, in which the connecting member has a groove for accommodating the permanent magnet, and the driving member is an electromagnet facing the permanent magnet, and the electromagnet includes a magnetic core and a coil surrounding the magnetic core, and the switch is configured to energize the coil to change polarity of the magnetic core when the switch is pressed by the pressing portion, so that the magnetic core changes from attracting the permanent magnet to repelling the permanent magnet or from repelling the permanent magnet to attracting the permanent magnet, so that the connecting member and the second end of the interference component are moved.

In some embodiments of the present disclosure, the knob structure further includes: an upper cover, fixed on the side cover and covering the internal tooth portion of the knob, in which the upper cover has a second opening, and the first end of the interference component is through the second opening.

In some embodiments of the present disclosure, the knob structure further includes: a second torsion spring, connected between the upper cover and the interference component.

The present disclosure further provides a headphone, which includes the above-mentioned knob structure for adjusting the sound parameter.

### BRIEF DESCRIPTION OF THE DRAWINGS

Aspects of the present disclosure are best understood from the following embodiments, read in conjunction with accompanying drawings. However, it should be understood that in accordance with common practice in the industry, various features have not necessarily been drawn to scale. Indeed, shapes of the various features may be suitably adjusted for clarity, and dimensions of the various features may be arbitrarily increased or decreased.

FIG. 1 is a perspective exploded view of a knob, an encoder and an interference component of a knob structure according to an embodiment of the present invention.

FIG. 2 is a cross-sectional view of the knob, the encoder and the interference component of FIG. 1.

FIG. 3 is a perspective view of a knob structure with a first operating feel according to an embodiment of the present invention.

FIG. 4 is a perspective view of a switching module of the knob structure of FIG. 3.

FIG. 5 is a perspective view of a knob structure with a second operating feel according to an embodiment of the present invention.

FIG. 6 is a perspective view of a switching module of the knob structure of FIG. 5.

FIG. 7 is a perspective view of a connecting member and a permanent magnet according to an embodiment of the present invention.

FIG. 8 is a perspective view of an electromagnet according to an embodiment of the present invention.

FIG. 9 is a perspective view of part of a headphone including a knob structure according to an embodiment of the present invention.

### DETAIL DESCRIPTION OF THE PREFERRED EMBODIMENT

The advantages and features of the present disclosure and the method for achieving the same will be described in more detail with reference to exemplary embodiments and accompanying drawings to make it easier to understand. However, the present disclosure can be implemented in different forms and should not be construed as being limited to the embodiments set forth herein. On the contrary, for those skilled in the art, the provided embodiments will make this disclosure more thorough, comprehensive and complete to convey the scope of the present disclosure.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180°, the relationship between the one element and the other element may change from “beneath” to “over.” The spatially relative descriptions used herein should be interpreted the same.

As mentioned in background of the invention, volume of an existing sound source input device is adjusted through a scroll wheel with a single step-feel design or a stepless-feel design. However, the user sometimes needs to adjust the volume greatly and sometimes needs to adjust the volume finely. Therefore, the scroll wheel of the sound source input device is inconvenient for the user. In addition, an operating feel of the scroll wheel with the stepless-feel design is unclear. Accordingly, the present invention provides a knob structure for adjusting a sound parameter (e.g., volume, audio frequency or pitch, but the present invention is not limited thereto), which includes a knob, an encoder, an interference component and a switching module. The design of the encoder, the interference component and the switching module can provide two operating feels for the user to switch, so that the user can make large adjustments or fine adjustments to the sound parameter. Various embodiments of the knob structure of the present invention will be described below in detail.

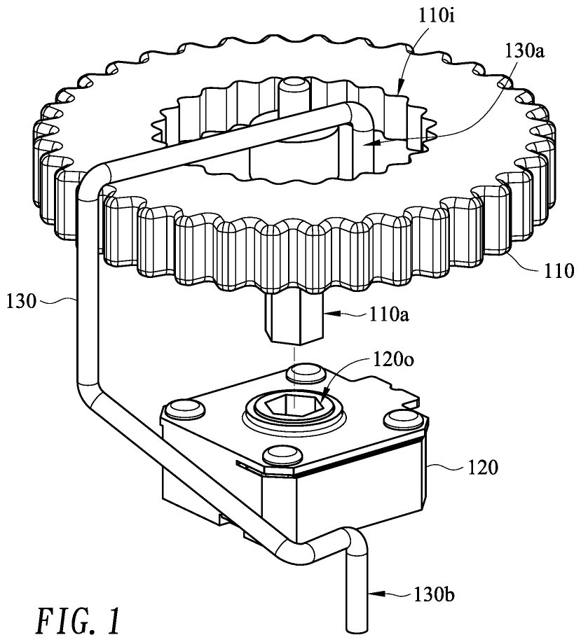

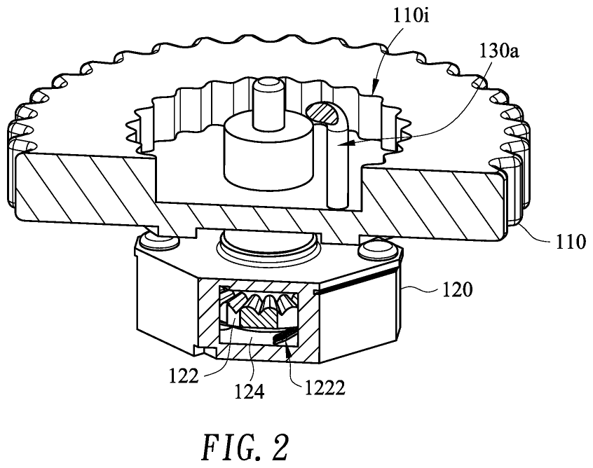

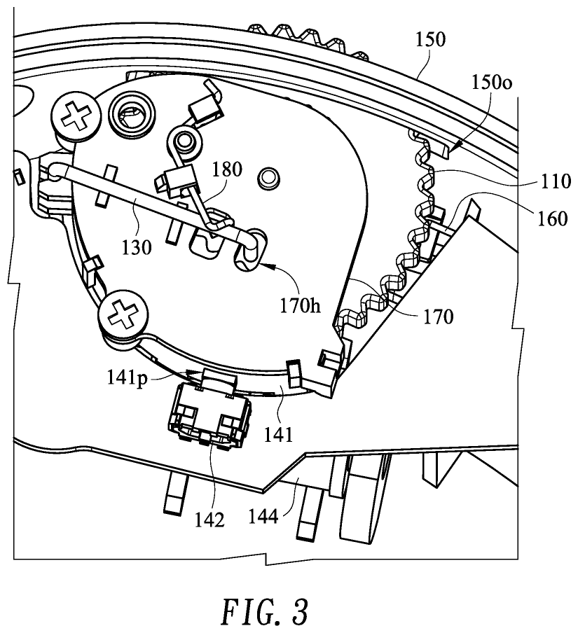

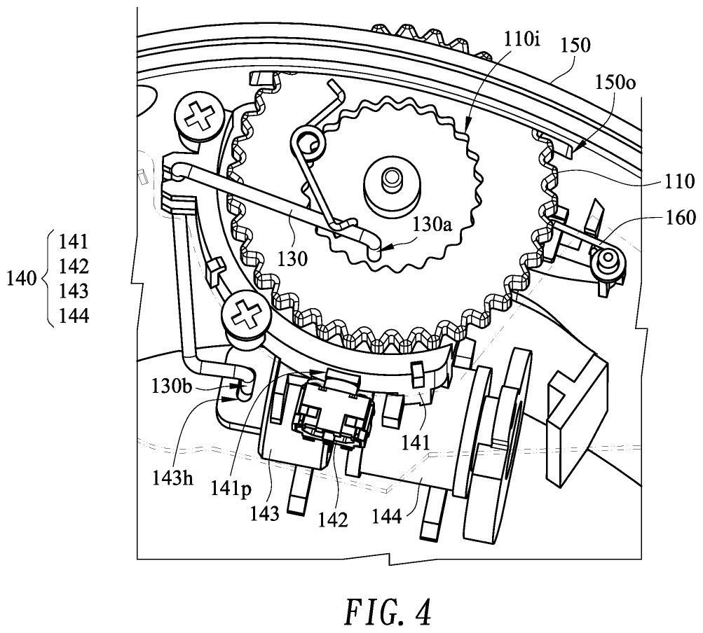

FIG. 1 is a perspective exploded view of a knob, an encoder and an interference component of a knob structure according to an embodiment of the present invention. FIG. 2 is a cross-sectional view of the knob, the encoder and the interference component of FIG. 1. FIG. 3 is a perspective view of a knob structure with a first operating feel according to an embodiment of the present invention. FIG. 4 is a perspective view of a switching module of the knob structure of FIG. 3. As shown in FIGS. 1 to 4, the knob structure for adjusting a sound parameter includes a knob 110, an encoder 120, an interference element 130 and a switching module 140.

As shown in FIG. 1, the knob 110 has a shaft portion 110a and an internal tooth portion 110i. In some embodiments, the shaft portion 110a and the internal tooth portion 110i are respectively located on opposite sides of the knob 110. In some embodiments, a cross-sectional shape of the shaft portion 110a is non-circular, such as polygonal (e.g., hexagonal).

As shown in FIGS. 1 and 2, the encoder 120 is connected to the shaft portion 110a of the knob 110. In some embodiments, the encoder 120 has an opening 1200 that accommodates a portion of the shaft portion 110a of the knob 110. A cross-sectional shape of the opening 1200 is non-circular, such as polygonal (e.g., hexagonal).

As shown in FIG. 2, the encoder 120 includes a turntable 122 and a bottom plate 124. The turntable 122 is substantially parallel to the knob 110. The turntable 122 has one or more protrusions 1222 in contact with the bottom plate 124. In some embodiments, the one or more protrusions 1222 protrude from a lower surface of the turntable 122. In some embodiments, the protrusion 1222 is a conductive elastic piece, such as a metal elastic piece. When the knob 110 is rotated to rotate the turntable 122 of the encoder 120 through the shaft portion 110a of the knob 110, the one or more protrusions 1222 rub against the bottom plate 124, thereby generating a friction feel (i.e., the first operating feel). In some embodiments, the bottom plate 124 has a plurality of conductive pads (not shown, which may be metal pads) arranged separately; when the knob 110 is rotated to rotate the turntable 122 of the encoder 120, the one or more protrusions 1222 intermittently rub the metal pads to produce a friction feel with a step-feel. In practical applications, an operating force of the encoder 120 may be adjusted appropriately. In some embodiments, the operating force of the encoder 120 is in a range of from 5 grams to 15 grams, so that a frictional feel with a slight step-feel may be produced when the knob 110 is rotated.

As shown in FIGS. 1 to 4, the interference component (or can be called a connecting rod) 130 has a first end 130a adjacent to the internal tooth portion 110i of the knob 110. The interference component 130 further has a second end 130b opposite to the first end 130a.

As shown in FIG. 4, the switching module 140 is configured to make the first end 130a of the interference component 130 be in contact with or moved away from the internal tooth portion 110i of the knob 110. The switching module 140 may be, for example, a mechanical switching module or an electrical switching module. Several embodiments of the switching module 140 will be described below in detail. However, it should be noted that the present invention is not limited thereto.

In some embodiments, as shown in FIGS. 3 and 4, the switching module 140 includes a side cover 141, a switch 142, a connecting member 143 and a driving member 144. The knob 110 has an outer diameter portion (not marked), and the side cover 141 is adjacent to a portion of the outer diameter portion. The side cover 141 has a pressing portion 141p facing away from the knob 110. The pressing portion 141p may protrude from a surface of the side cover 141 (as shown in FIG. 4) or may not protrude (not shown). In some embodiments, when the knob 110 is not pressed, the outer diameter portion of the knob 110 and the side cover 141 are adjacent to each other but separated by a distance.

The switch (or can be called a push switch) 142 abuts against the pressing portion 141p. In some embodiments, the switch has an abutting portion (not marked) that abuts against the pressing portion 141p. In some embodiments, the switch 142 is a Z-axis switch. In some embodiments, the switch 142 is fixed on a substrate (not marked).

As shown in FIGS. 1 and 4, the connecting member 143 is connected to the second end 130b of the interference component 130. In some embodiments, as shown in FIG. 4, the connecting member 143 has a first opening 143h that accommodates the second end 130b of the interference component 130. In some embodiments, as shown in FIGS. 1 and 4, the interference component 130 further has a connecting portion (not marked) between the first end 130a and the second end 130b, and a portion of the connecting portion is engaged with a hook portion (not marked) of the side cover 141.

The driving member 144 is configured to move the connecting member 143. The switch 142 and the driving member 144 are electrically connected. When the switch 142 is pressed, the switch 142 drives the driving member 144; when the switch 142 is pressed again, the switch 142 does not drive the driving member 144. In some embodiments, the driving member 144 and the connecting member 143 are adjacent to each other but separated by a distance (as shown in FIG. 4), or are in contact with each other (not shown), or are integrally formed (not shown).

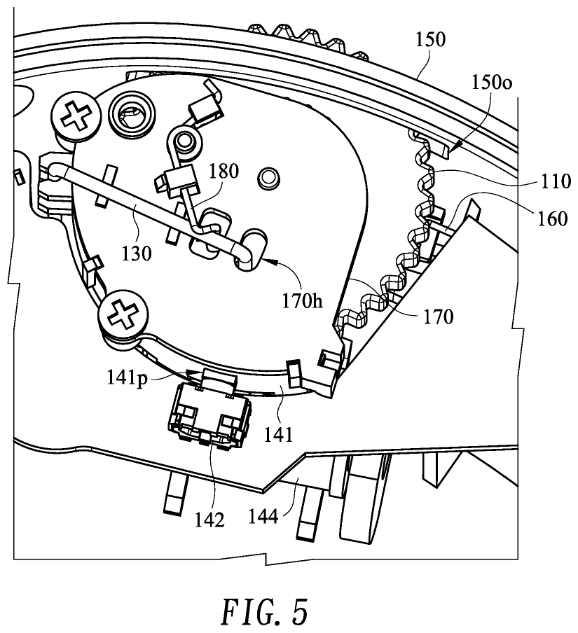

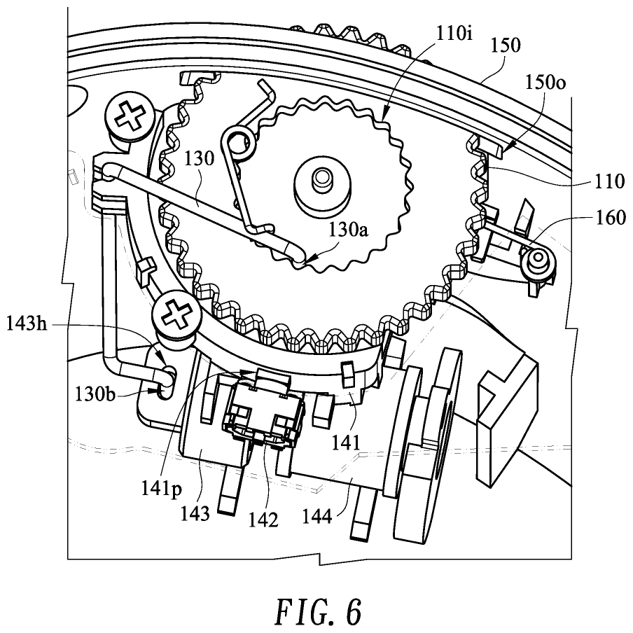

FIG. 5 is a perspective view of a knob structure with a second operating feel according to an embodiment of the present invention. FIG. 6 is a perspective view of a switching module of the knob structure of FIG. 5. Please refer to FIGS. 3 and 4 and FIGS. 5 and 6, when the knob 110 is pressed, the portion of the outer diameter portion of the knob 110 is pushed against the side cover 141, causing the pressing portion 141p of the side cover 141 to press the switch 142 (e.g., pressing the abutting portion of the switch 142) to drive the driving member 144, so that the connecting member 143 is moved, and the second end 130b of the interference component 130 is moved accordingly, so that the first end 130a of the interference component 130 is in contact with or moved away from the inner tooth portion 110i. After the switch 142 is pressed, the abutting portion of the switch 142 rebounds, so that the side cover 141 and the knob 110 return to their original positions.

In some embodiments, please refer to FIGS. 3 and 4 and FIGS. 5 and 6 in sequence. When the knob 110 is pressed, the switch 142 drives the driving member 144, and action of the driving member 144 causes the connecting member 143 to move away from the driving member 142, and the second end 130b of the interference component 130 is moved away from the driving member 142 accordingly, and thus the first end 130a of the interference component 130 is in contact with the internal tooth portion 110i. Therefore, subsequently, when the knob 110 is rotated, the user can feel an obvious step-feel (i.e. the second operating feel) to facilitate the user to fine-tune the sound parameter. Please refer to FIGS. 5 and 6 and FIGS. 3 and 4 in sequence. When the knob 110 is pressed again, the switch 142 does not drive the driving member 144, so that the connecting member 143 returns to its original position, and the second end 130b of the interference component 130 returns to its original position accordingly, and thus the first end 130a of the interference component 130 is moved away from the internal tooth portion 110i. Therefore, subsequently, when the knob 110 is rotated, the user can feel the friction feel (i.e., the aforementioned first operating feel).

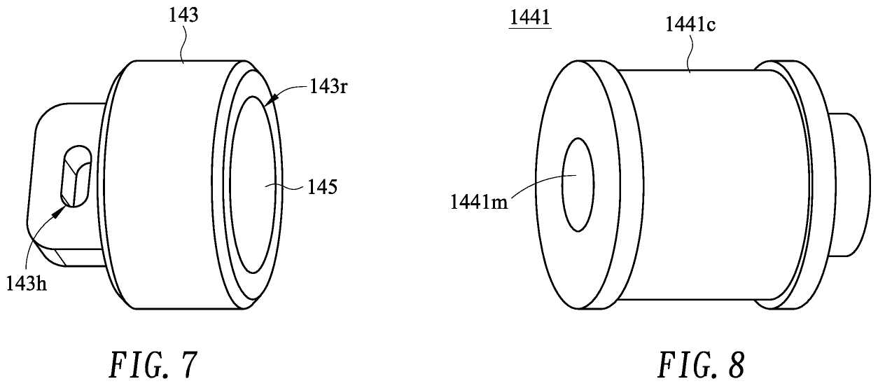

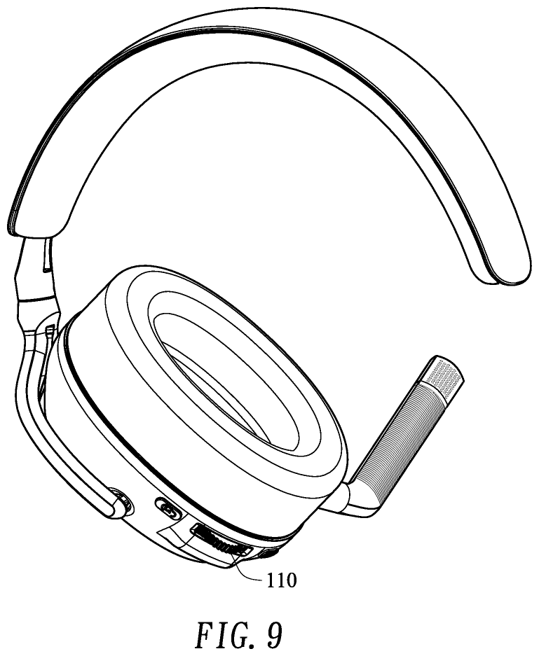

The driving member 144 may be, for example, an electromagnet or a motor. An embodiment in which the driving member 144 is the electromagnet will be described below in detail. FIG. 7 is a perspective view of a connecting member and a permanent magnet according to an embodiment of the present invention. In some embodiments, referring to FIGS. 4 and 7, the switching module 140 further includes a permanent magnet 145, and the connecting member 143 has a groove 143r for accommodating the permanent magnet 145. FIG. 8 is a perspective view of an electromagnet according to an embodiment of the present invention. In some embodiments, referring to FIGS. 4 and 8, the driving member 144 is an electromagnet 1441 facing the permanent magnet 145. The electromagnet 1441 includes a magnetic core 1441m and a coil 1441c surrounding the magnetic core 1441m. In some embodiments, referring to FIGS. 4, 6, 7, and 8, the permanent magnet 145 and the electromagnet 1441 are adjacent to each other but separated by a distance. The switch 142 is configured to energize the coil 1441c to change polarity of the magnetic core 1441m when the switch 142 is pressed by the pressing portion 141p, so that the magnetic core 1441m changes from attracting the permanent magnet 145 to repelling the permanent magnet 145, or from repelling the permanent magnet 145 to attracting the permanent magnet 145, so that the connecting member 143 is moved, and the second end 130b of the interference component 130 is moved accordingly (e.g., the connecting member 143 and the second end 130b of the interference component 130 are moved away from or closer to the electromagnet 1441), so that the first end 130a of the interference component 130 is moved.

An embodiment in which the driving member 144 is the motor will be described below in detail. Please refer to FIGS. 3 and 4, the driving member 144 and the connecting member are in contact with each other (not shown) or are integrally formed (not shown). The switch 142 is configured to drive the motor to move the connecting member 143 when the switch 142 is pressed by the pressing portion 141p, and the second end 130b of the interference component 130 is moved accordingly, so that the first end 130a of the interference component 130 is moved.

In some embodiments, as shown in FIGS. 3 and 4, the knob structure further includes an outer casing 150, which has an opening region 1500 exposing a portion of the outer diameter portion of the knob 110 for the user to rotate the knob 110. In some embodiments, the substrate carrying the switch 142 is fixed within the outer casing 150, such as being fixed on a bracket (not marked) of the outer casing 150.

In some embodiments, as shown in FIGS. 3 and 4, the knob structure further includes a first torsion spring 160 connected between the side cover 141 and the outer casing 150. The first torsion spring 160 is configured to assist the side cover 141 and the knob 110 to quickly return to their original positions after the knob 110 is pressed.

In some embodiments, as shown in FIGS. 3 and 4, the knob structure further includes an upper cover 170 fixed on the side cover 141 and covering the internal tooth portion 110i of the knob 110. The upper cover 170 has a second opening 170h, and the first end 130a of the interference component 130 is through the second opening 170h.

In some embodiments, as shown in FIG. 3, the knob structure further includes a second torsion spring 180 connected between the upper cover 170 and the interference component 130.

FIG. 9 is a perspective view of part of a headphone including a knob structure according to an embodiment of the present invention (only a headband portion and a single earmuff portion of the headphone are shown). Please refer to FIG. 9, the present invention provides a headphone, which includes the above-mentioned knob structure that can provide the two operating feels to facilitate the user to adjust the sound parameter by operating the knob 110.

However, the above are only the preferred embodiments of the present disclosure, and should not be used to limit the scope of implementation of the present disclosure, that is, simple equivalent changes and modifications made in accordance with claims and description of the present disclosure are still within the scope of the present disclosure. In addition, any embodiment of the present disclosure or claim does not need to achieve all the objectives or advantages disclosed in the present disclosure. In addition, the abstract and the title are not intended to limit the scope of claims of the present disclosure.

What is claimed is:

1. A knob structure for adjusting a sound parameter, comprising:
a knob, having a shaft portion and an internal tooth portion;
an encoder, connected to the shaft portion of the knob, wherein the encoder comprises a turntable and a bottom plate, and the turntable has one or more protrusions in contact with the bottom plate, and when the knob is rotated to rotate the turntable of the encoder, the one or more protrusions rub against the bottom plate;
an interference component, having a first end adjacent to the internal tooth portion of the knob; and
a switching module, configured to make the first end of the interference component be in contact with or moved away from the internal teeth portion of the knob.

2. The knob structure of claim 1, wherein the encoder has an opening that accommodates a portion of the shaft portion of the knob.

3. The knob structure of claim 1, wherein the switching module comprises:
a side cover, wherein the knob further has an outer diameter portion, and the side cover is adjacent to a portion of the outer diameter portion and has a pressing portion facing away from the knob;
a switch, abutting against the pressing portion;
a connecting member, wherein the interference component further has a second end opposite to the first end, and the connecting member is connected to the second end of the interference component; and
a driving member, configured to move the connecting member,
wherein when the knob is pressed, the portion of the outer diameter portion of the knob is pushed against the side cover, causing the pressing portion of the side cover to press the switch to drive the driving member, so that the connecting member and the second end of the interference component are moved, so that the first end of the interference component is in contact with or moved away from the internal tooth portion.

4. The knob structure of claim 3, wherein the connecting member has a first opening that accommodates the second end of the interference component.

5. The knob structure of claim 3, further comprising:
an outer casing, having an opening region exposing another portion of the outer diameter portion of the knob.

6. The knob structure of claim 5, further comprising:
a first torsion spring, connected between the side cover and the outer casing.

7. The knob structure of claim 3, wherein the switching module further comprises:
a permanent magnet, wherein the connecting member has a groove for accommodating the permanent magnet, and the driving member is an electromagnet facing the permanent magnet, and the electromagnet comprises a magnetic core and a coil surrounding the magnetic core, and the switch is configured to energize the coil to change polarity of the magnetic core when the switch is pressed by the pressing portion, so that the magnetic core changes from attracting the permanent magnet to repelling the permanent magnet or from repelling the permanent magnet to attracting the permanent magnet, so that the connecting member and the second end of the interference component are moved.

8. The knob structure of claim 3, further comprising:
an upper cover, fixed on the side cover and covering the internal tooth portion of the knob, wherein the upper cover has a second opening, and the first end of the interference component is through the second opening.

9. The knob structure of claim 8, further comprising:
a second torsion spring, connected between the upper cover and the interference component.

10. A headphone, comprising the knob structure for adjusting the sound parameter of claim 1.
